(19) United States
(12) Patent Application Publication
(10) Pub. No.: US 2011/0035418 A1
(43) Pub. Date: Feb. 10, 2011

(54) Object-Knowledge Mapping Method

(75) Inventor: Robert A. Butler, IV, Lewisville, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/537,062

(22) Filed: Aug. 6, 2009

(51) Int. Cl. G06F 17/30

(52) U.S. Cl. 707/809; 707/E17.055

(57) ABSTRACT

According to one embodiment, a method for mapping a data model to an object model comprising receiving an ontology. The ontology provides a definition of a concept. The concept classifies a Resource Description Framework (RDF) expression stored in a knowledge store. A mapping file is generated. The mapping files defines a mapping relationship between the concept and an object representation of the concept. A class is generated according to the object representation of the concept. The class provides a class definition of an object. The object is generated according to the class definition. The object is mapped to the RDF expression according to the mapping relationship.

### TECHNICAL FIELD

This invention relates generally to the field of computer programming and more specifically to an object-knowledge mapping method.

### BACKGROUND

In computer science, code is any collection of statements or declarations written in a computer-executable language. The computer-executable language may be based on a programming paradigm. A programming paradigm is a style of computer programming. A programming paradigm may define a mechanism for representing programming elements. Different programming paradigms may differ in their representation of programming elements.

### SUMMARY OF THE DISCLOSURE

According to one embodiment, a method for mapping a data model to an object model comprising receiving an ontology. The ontology provides a definition of a concept. The concept classifies a Resource Description Framework (RDF) expression stored in a knowledge store. A mapping file is generated. The mapping files defines a mapping relationship between the concept and an object representation of the concept. A class is generated according to the object representation of the concept. The class provides a class definition of an object. The object is generated according to the class definition. The object is mapped to the RDF expression according to the mapping relationship. The RDF expression may be identified according to a query of the knowledge store. The query may be an object-oriented query language, which is then translated into a query operable to retrieve the RDF expression from the knowledge store.

Certain embodiments of the invention may provide one or more technical advantages. A technical advantage of one embodiment may be the capability to map objects to knowledge stores, such as an RDF knowledge stores. Yet other technical advantages may include the capability to provide a query language for retrieving objects from a knowledge store. Still yet other technical advantages may include the capability to automatically generate objects from RDF ontologies. Still yet other technical advantages may include the capability to provide a caching mechanism that may enhance performance by reducing the number of interactions with a knowledge store. Still yet other technical advantages may include the capability to provide methods for RDF operations that do not translate directly to an object representation.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of an object-knowledge mapping system;

FIG. 2 illustrates one embodiment of a method for generating code; and

FIG. 3 presents an embodiment of a general purpose computer operable to perform one or more operations of various embodiments of the invention.

### DETAILED DESCRIPTION

It should be understood at the outset that, although example implementations of embodiments are illustrated below, the present invention may be implemented using any number of techniques, whether currently known or not. The present invention should in no way be limited to the example implementations, drawings, and techniques illustrated below. Additionally, the drawings are not necessarily drawn to scale.

Data representations may include different types and formats, and different data representations may not be compatible. For example, object representations may not be compatible with other knowledge representations, such as Resource Description Framework (RDF) expressions. Accordingly, teachings of certain embodiments recognize the use of data mapping mechanisms. Data mapping is a programming technique for converting data between incompatible data representations.

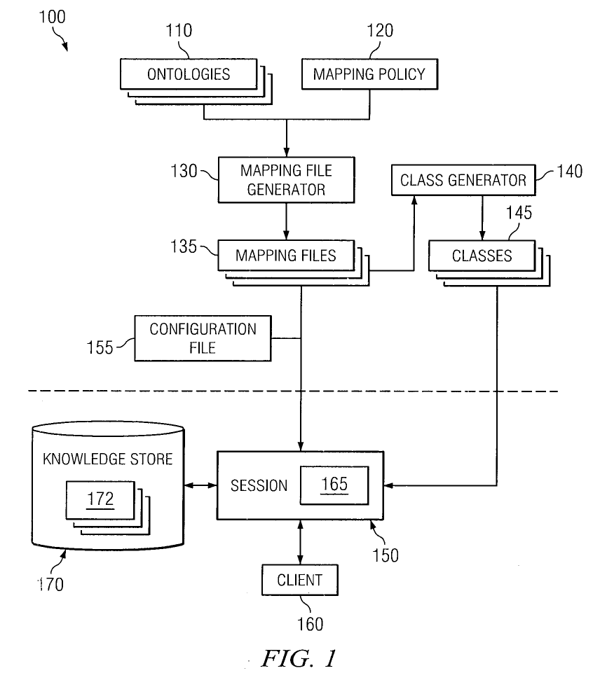

FIG. 1 illustrates one embodiment of an object-knowledge mapping system 100. The components of the object-knowledge mapping system 100 of FIG. 1 may include one or more ontolog(ies) 110, one or mapping policies 120, a mapping files generator 130, one or more mapping files 135, a class generator 140, one or more classes 145, one or more sessions 150, one or more configuration files 155, one or more clients 160, one or more session caches 165, one or more knowledge stores 170, and one or more data records 172. The illustrated embodiment is described on a per-client bases for illustrative purposes; however, other embodiments may include multiple clients 160. In the illustrated embodiment, the ontologies 110, the mapping policy 120, the mapping file generator 130, the mapping files 135, the class generator 140, the classes 145, and the configuration file 155 exist and operate in a compile-time environment, and the session 150, the client 160, and the knowledge store 170 exist and operate in a run-time environment. However, embodiments of the knowledge mapping system 100 are not limited to the compile-time/run-time configuration illustrated in FIG. 1. Rather, embodiments of the components of the object-knowledge mapping system 100 may include both compile-time and run-time varieties.

The ontologies 110 may include any formal representation of a set of concepts within a domain, the properties of those concepts, and the relationships between those concepts. The concepts may classify instances of the concepts, other concepts, or a combination of both. In some embodiments, the instances may be stored as data records 172 in the knowledge store 170. In these embodiments, the ontologies 110 provide a shared vocabulary for the data records 172. In some embodiments, the ontologies 110 may be stored as data records 172.

For example, an ontology 110 may define a concept “car.” One instance of a car is a Ford Explorer. The Ford Explorer may have several properties: a name (e.g., Ford Explorer), an engine (e.g., 4.0 liter engine), a transmission (e.g., 6-speed transmission), and an interior (e.g., leather). Instances of the concept “car” may have relationships to other instances of the concept “car.” For example, the instance Ford Explorer may have a defined relationship to its predecessor, the Ford Bronco. A concept can also subsume other concepts; for example, a concept “vehicle” may subsume the concept “car” because every instance of a car must be an instance of a vehicle. Subsumption relationships may be used to create hierarchies of concepts.

The ontologies 110 may be encoded according to an ontology language. Two examples of an ontology language for describing RDF expressions are the Web Ontology Language (OWL) and RDF Schema. Other embodiments of the ontologies 110 may be encoded according to other knowledge representation languages.

The mapping policy 120 may identify the ontologies 110 and provide a mapping definition for each ontology 110. The mapping definition may also provide information such as name changes to ontology 110 concepts and a target directory for the mapping data. The mapping policy 120 may also identify an object representation of the concepts defined by the ontologies 110. This object representation may provide a paradigm for object-oriented programming concepts. Examples of object-oriented programming concepts include classes, objects, and inheritance. An object is an instance of a class. In turn, a class defines the abstract features of the object, including the object's characteristics (which may correspond to properties) and the object's behaviors, or “methods.” A method is a subroutine that is exclusively associated with a class or an object. A method may include a sequence of statements to perform an action, a set of input parameters to customize the action, and possibly an output value. Methods provide a mechanism for accessing the data stored in an object or class. Inheritance is the ability of a subclass to inherit attributes and methods from a parent class.

The ontologies 110 and the mapping policy 120 may be passed to a mapping file generator 130. The mapping file generator 130 creates one or more mapping files 135. The mapping files 135 may include mapping data that describes how objects map to the concepts defined by the ontology 110, as well as how methods map to the properties defined by the ontology 110. The methods may include behaviors of the objects, such as computations that may be performed in connection with the objects or properties of the objects that may change over time. These behaviors may also be represented by a concrete class, and the mapping file may require that objects of a specified type are to extend to the concrete class.

The mapping files 135 may also map objects for which there is no equivalent concept defined by the ontologies 110. In one embodiment, an object may be created that represents a more specific instance of a concept in the ontology 110 but adds some constraint. This object may create a mechanism for querying across ontological concepts. For example, if the client 160 desires to load all objects that have a date or time associated with them, a “Temporal” class may be specified in the mapping file 135 that maps the data records 172 with a date or time property. In this example, the “Temporal” class may return any data records 172 that have a date or time property.

In some embodiments, methods may be provided to perform operations on the data records 172 that may not translate to an object representation. Objects may be dynamically casted to different types, and new types may be added to existing objects, without requiring the session 150 to manage multiple instances of the same object. For example, a list of data records 172 may be retrieved by mapping a query of the data records 172 to an object representation of a list. In another example, the list of data records 172 may be created using a behavior mapped to a concrete class.

Embodiments provide at least two mechanisms for updating or modifying the mapping files 135. First, the ontologies 110 or the mapping policy 120 may be modified, and then the mapping files 135 may be regenerated from the mapping file generator 130. Second, the mapping files 135 may be edited directly. For example, the mapping files 135 may be edited to provide custom classes or add custom behavior to the generated classes 145.

The mapping files 135 may then be passed to the class generator 140. The class generator 140 may then create one or more classes 145 according to the mapping data included in the mapping files 135. In some embodiments, the class generator 140 may create more than one class 145 for every mapping file 135. In some embodiments, the classes 145 may be represented by java classes. However, embodiments of the classes 145 may be represented in any programming language.

The mapping files 135 and the classes 145 may be passed to the session 150. The session 150 may be opened by the client 160 for interacting with the other components of the object-knowledge mapping system 100. The session 150 may exist temporarily or permanently. In some embodiments, the session 150 may be closed and later replaced with a new session 150.

In some embodiments, the session 150 may consult the configuration file 155. The configuration file 155 may define what the session 150 connects to. For example, the configuration file 155 may identify the knowledge store 170, provide information for accessing the knowledge store 170, identify the mapping files 135, and the classes 145.

The session 150 synchronizes the classes 145 with the data records 172 stored in the knowledge store 170 and provides an object-oriented representation of the data records 172 to the client 160. The object-oriented representation may be in the form of an application programming interface (API).

For example, the client 160 may include a software application with a programming paradigm based on object-oriented programming concepts. In some embodiments, the software application may be a java application. In some examples, the client 160 may order the session 150 to perform an operation on an object. Alternatively viewed, the client 160 may manipulate the object itself, which will cause the session 150 to perform the operation. The session 150 may use the appropriate mapping file 135 to map the object to the appropriate data record 172 and then persist these changes to the knowledge store 170 as appropriate.

Embodiments of the session 150 may include a variety of different APIs to retrieve objects for the client 160. For example, an introspection API may provide a dynamic discovery mechanism for viewing the properties of an object or an instance of an object. Thus, the session 150 may retrieve an object and then retrieve all properties associated with the object using the introspection API. In some embodiments, the introspection API may discover all properties of the object, regardless of whether the properties are explicitly mapped to the current object type. Another example of a session 150 API is an adapter API, allowing the session 150 to interact with any knowledge store 170 or any client 160.

In some embodiments, the session 150 may include a session cache 165. Teachings of certain embodiments recognize that a caching mechanism may enhance performance when interacting with a knowledge store by reducing the number of interactions with the knowledge store 170.

The session cache 165 may include an initial set of data records that correspond to the data records 172. The session 150 may build the session cache 165 by executing a query to retrieve an initial working set of data records 172 and then identifying objects that map to those data records 172. In some embodiments, the session 150 may use the session cache 165 to store temporary objects and data records and then perform bulk synchronization operations with the knowledge store 170. In some embodiments, the session 150 may maintain the session cache 165 until the close of the session 150; at the close of the session 150, the session 150 may persist any changes to the knowledge store 170.

In some embodiments, the session 150 may operate with the session cache 165 without having an attached knowledge store 170; the session 150 can manage changes to the data records 172 in the session cache 165 and then persist those changes to the knowledge store 170 whenever the knowledge store 170 becomes available. In another embodiments, a data file may incorporate information from the mapping files 135, the classes 145, and the data records 172. For example, the data file may wrap information from the mapping files 135, the classes 145, and the data records 172; the data file may then be passed to a client not connected to the object-knowledge mapping system 100, and the client may unwrap the data file and use the information stored inside.

The knowledge store 170 may include any structured collection of data records 172. The data records 172 may represent a conceptual description or modeling of information. Embodiments of the data records 172 may be defined according to a semantic data model. A semantic data model is a data-modeling technique to define the meaning of data within the context of its interrelationships with other data.

In some embodiments, the data records 172 may be defined as an RDF expression. An example of an RDF expression is an RDF triple, which describes data in the form of a subject-predicate-object expression. The subject denotes the resource. The predicate denotes traits or aspects of the resource and expresses a relationship between the subject and the object. For example, the notion “the sky has the color blue” may be expressed as an RDF triple: a subject denoting “the sky,” a predicate denoting “has the color,” and an object denoting “blue.”

In some embodiments, the data records 172 may be individually read and written. For example, the data records 172 may be retrieved according to an identifier. In other embodiments, collections of the data records 172 may be accessed using a query executed using a query language. In some embodiments, the query language may be executed in an object-oriented query language. This object-oriented query may then be translated into a query operable to retrieve the data records 172. In several embodiments, queries may be executed to retrieve the data records 172 according to an RDF query language such as SPARQL Protocol and RDF Query Language (“SPARQL”). Other examples of a query language may include RDF query language (RDQL), Versa, and XML User Interface Language (XUL). In some embodiments, a query of the data records 172 may be returned to the client 160 as mapped to an object representation.

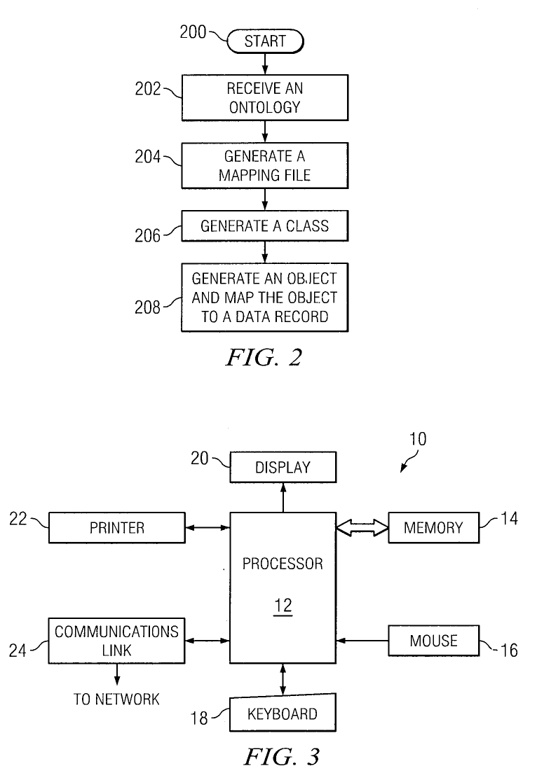

FIG. 2 illustrates one embodiment of a method for generating code. The method of FIG. 2 may incorporate one or more components of the code generation system of FIG. 1.

The method of FIG. 2 starts at step 200. At step 202, an ontology is received. One example of the ontology of step 202 may be the ontology 110 from FIG. 1. At step 204, a mapping file is generated. One example of the mapping file of step 204 may be the mapping file 135 of FIG. 1. For example, step 204 may be performed by the mapping file generator 130, which receives the ontology 110 and the mapping policy 120 and generates the mapping file 135.

At step 206, a class is generated. One example of the class generated at step 206 may include the class 145 of FIG. 1. For example, step 206 may be performed by the class generator 140, which receives the mapping file 135 and generates the class 145. At step 208, an object is generated and mapped to a data record. In one embodiment, step 208 may be performed by the session 150 of FIG. 1, which may generate an object representation of the data records 172 by mapping the data records 172 to appropriate objects.

FIG. 3 presents an embodiment of a general purpose computer 10 operable to perform one or more operations of various embodiments of the invention. The general purpose computer 10 may generally be adapted to execute any of the well-known OS2, UNIX, Mac-OS, Linux, and Windows Operating Systems or other operating systems. The general purpose computer 10 in this embodiment comprises a processor 12, a memory 14, a mouse 16, a keyboard 18, and input/output devices such as a display 20, a printer 22, and a communications link 24. In other embodiments, the general purpose computer 10 may include more, less, or other component parts.

Several embodiments may include logic contained within a medium. Logic may include hardware, software, and/or other logic. Logic may be encoded in one or more tangible media and may perform operations when executed by a computer. Certain logic, such as the processor 12, may manage the operation of the general purpose computer 10. Examples of the processor 12 include one or more microprocessors, one or more applications, and/or other logic. Certain logic may include a computer program, software, computer executable instructions, and/or instructions capable being executed by the general purpose computer 10. In particular embodiments, the operations of the embodiments may be performed by one or more computer readable media storing, embodied with, and/or encoded with a computer program and/or having a stored and/or an encoded computer program. The logic may also be embedded within any other suitable medium without departing from the scope of the invention.

The logic may be stored on a medium such as the memory 14. The memory 14 may comprise one or more tangible, computer-readable, and/or computer-executable storage medium. Examples of the memory 14 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

The communications link 24 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding.

Although the illustrated embodiment provides one embodiment of a computer that may be used with other embodiments of the invention, such other embodiments may additionally utilize computers other than general purpose computers as well as general purpose computers without conventional operating systems. Additionally, embodiments of the invention may also employ multiple general purpose computers 10 or other computers networked together in a computer network. For example, multiple general purpose computers 10 or other computers may be networked through the Internet and/or in a client server network. Embodiments of the invention may also be used with a combination of separate computer networks each linked together by a private or a public network.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A method for mapping a data model to an object model, comprising:
receiving an ontology, the ontology providing a definition of a concept, the concept classifying a Resource Description Framework (RDF) expression stored in a knowledge store;
generating a mapping file, the mapping file defining a mapping relationship between the concept and an object representation of the concept;
generating a class according to the object representation of the concept, the class providing a class definition of an object;
generating the object according to the class definition; and
using a computer system, mapping the object to the RDF expression according to the mapping relationship.

2. The method of claim 1, wherein the RDF expression is an RDF triple.

3. The method of claim 1, wherein the generating a mapping file comprises:
consulting a mapping policy, the mapping policy identifying the ontology and providing a mapping definition for mapping the concept to the class; and
generating the mapping file based on the mapping policy and the ontology.

4. The method of claim 1, further comprising:
generating a session, the session operable to communicate the object to a client.

5. The method of claim 4, wherein the session provides an application programming interface to the client.

6. The method of claim 4, further comprising:
generating a session cache within the session, the session cache operable to store a temporary cache of objects.

7. The method of claim 6, further comprising:
modifying the temporary cache of objects based on instructions received from the client; and
persisting the modifications of the temporary cache of objects to the knowledge store by mapping the objects to the RDF expressions.

8. The method of claim 4, wherein the session consults a configuration file, the configuration file identifying the knowledge store and the mapping files.

9. The method of claim 6, further comprising:
querying the knowledge store for an initial set of RDF expressions; and
generating the temporary cache of objects by identifying objects that map to the initial set of RDF expressions.

10. The method of claim 1, further comprising:
wrapping the mapping file, the class, and the RDF expression in an data file; and
communicating the data file to a client that is not in communication with the knowledge store.

11. The method of claim 1, wherein the RDF expression is identified according to a query of the knowledge store.

12. The method of claim 11, wherein the query is an object-oriented query executed in an object-oriented query language, the method further comprising translating the object-oriented query into a query operable to retrieve the RDF expression from the knowledge store.

13. The method of claim 1, further comprising:
generating a concrete class, the concrete class representing the behavior of an object type; and
extending the concrete class to objects of the object type.

14. The method of claim 1, further comprising:
embedding a query of the knowledge store into the class by adding a constraint to the class.

15. A computer-readable medium having computer-executable instructions, when executed by a computer configured to:
receive an ontology, the ontology providing a definition of a concept, the concept classifying a Resource Description Framework (RDF) expression stored in a knowledge store;
generate a mapping file, the mapping file defining a mapping relationship between the concept and an object representation of the concept;
generate a class according to the object representation of the concept, the class providing a class definition of an object;
generate the object according to the class definition; and
map the object to the RDF expression according to the mapping relationship.

16. The computer-readable medium of claim 15, wherein the RDF expression is an RDF triple.

17. The computer-readable medium of claim 15, the instructions when executed further configured to generate the mapping file by:
consulting a mapping policy, the mapping policy identifying the ontology and providing a mapping definition for mapping the concept to the class; and
generating the mapping file based on the mapping policy and the ontology.

18. The computer-readable medium of claim 15, the instructions when executed further configured to:
generate a session, the session operable to communicate the object to a client.

19. The computer-readable medium of claim 18, wherein the session provides an application programming interface to the client.

20. The computer-readable medium of claim 18, the instructions when executed further configured to:
generate a session cache within the session, the session cache operable to store a temporary cache of objects.

21. The computer-readable medium of claim 20, the instructions when executed further configured to:
modify the temporary cache of objects based on instructions received from the client; and
persist the modifications of the temporary cache of objects to the knowledge store by mapping the objects to the RDF expressions.

22. The computer-readable medium of claim 18, wherein the session consults a configuration file, the configuration file identifying the knowledge store and the mapping files.

23. The computer-readable medium of claim 20, the instructions when executed further configured to:
querying the knowledge store for an initial set of RDF expressions; and
generating the temporary cache of objects by identifying objects that map to the initial set of RDF expressions.

24. The computer-readable medium of claim 15, the instructions when executed further configured to:
wrap the mapping file, the class, and the RDF expression in an data file; and
communicate the data file to a client that is not in communication with the knowledge store.

25. The computer-readable medium of claim 15, the RDF expression is identified according to a query of the knowledge store.

26. The method of claim 25, wherein the query is an object-oriented query executed in an object-oriented query language, the instructions when executed further configured to translate the object-oriented query into a query operable to retrieve the RDF expression from the knowledge store.

27. The computer-readable medium of claim 15, the instructions when executed further configured to:
generate a concrete class, the concrete class representing the behavior of an object type; and
extend the concrete class to objects of the object type.

28. The computer-readable medium of claim 15, the instructions when executed further configured to:
embed a query of the knowledge store into the class by adding a constraint to the class.
